(19) United States
(12) Patent Application Publication
(10) Pub. No.: US 2002/0144995 A1
(43) Pub. Date: Oct. 10, 2002

(54) Microwave oven and information displaying method for the same

(75) Inventor: Yun-Bong Chun, Seoul (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/022,389

(22) Filed: Dec. 20, 2001

(30) Foreign Application Priority Data
Apr. 9, 2001 (KR) 2001-18683

(51) Int. Cl. H05B 6/68

(52) U.S. Cl. 219/720; 219/702

(57) ABSTRACT

An information displaying method for a microwave oven includes reading data including data that is one of data requested by a user and data required to be notified to a user from a data storage device, displaying the read data are displayed on a screen, setting scroll directions for the displayed data on the screen, and displaying the data in the set scroll directions. The microwave oven includes a display unit to display the data while scrolling the data on a screen, a storage unit to store the data to be displayed on the display unit, an input unit to set the scroll directions of data to be displayed, and a control unit to control the display of the data while scrolling the data in the set scroll directions.

### CROSS-REFERENCE TO RELATED APPLICATIONS

This application claims the benefit of Korean Application No. 2001-18683, filed Apr. 9, 2001, in the Korean Industrial Property Office, the disclosure of which is incorporated herein by reference.

### BACKGROUND OF THE INVENTION

1. Field of the Invention

The present invention relates to a microwave oven and information displaying method for the same that displays data including characters, symbols, figures, or combinations thereof on a screen while scrolling them.

2. Description of the Prior Art

In general, a microwave oven is an apparatus for cooking food using microwaves generated by a magnetron. In the microwave oven, a control panel is mounted on a front surface of an oven body for the convenience of a user. The control panel generally includes an input unit and a display unit.

The various functions of the microwave oven can be selected by a user through the input unit of the control panel, and information is displayed on the display unit of the control panel so as to aid the user to conveniently select the above functions. The information is usually in the form of data, such as characters, symbols, figures and combinations thereof, which were previously stored in an internal memory to be displayed on a single screen of the display unit.

Recently, as a variety of functions are added to microwave ovens, various attempts are made to display a larger amount of information on a display unit. Of the above attempts, Korean Patent No. 197694 discloses a microwave oven in which there is provided a display unit having a function of scrolling data across a screen.

Referring to FIG. 1, the conventional microwave oven includes a speed control switch 110, a memory 120, a timer 130, a microprocessor 140, and a display unit 150. The speed control switch 110 transmits a switching signal to the microprocessor 140 to control a scroll speed of character data in accordance with a control signal inputted by a user, the memory 120 to store the character data concerning the functions of the microwave oven, and the timer 130 to count a current time and to transmit it to the microprocessor 140.

The microprocessor 140 reads the character data corresponding to a currently performed function from the memory 120, and outputs a control signal to the display unit 150 to display the character data. The microprocessor 140 transmits a control signal to scroll the character data character-by-character according to a scroll speed adjusted through the speed control switch 110 using the current time counted by the timer 130. Accordingly, the display unit 150 displays the character data read from the memory 120 while scrolling the character data character-by-character according to the control signal transmitted from the microprocessor 140.

In the conventional microwave oven, the user controls the scroll speed of the character data displayed on the display unit 150 using the speed control switch 110. Thus, the attention of the user can be drawn to the character data showing the various functions of the conventional microwave oven.

However, in the conventional microwave oven, when the user sets a high scroll speed, the user cannot clearly recognize data because of the short display time of the data. Thus, the user must inconveniently reset the scroll speed to a low scroll speed. In contrast, when the user sets a low scroll speed, the user can clearly recognize the data, but there occurs the problem that a long period of time is required to display the data. Further, even when the user sets a proper scroll speed, it is inevitable that the user should endure inconvenience by having to scroll the data again to confirm whether the scroll speed is satisfactory.

### SUMMARY OF THE INVENTION

Accordingly, in order to solve the above and other problems, an object of the present invention is to provide a microwave oven and information displaying method for the same that displays data while scrolling the data in scroll directions and at scroll rates set by a user.

Additional objects and advantages of the invention will be set forth in part in the description which follows and, in part, will be obvious from the description, or may be learned by practice of the invention.

In order to accomplish the above and other objects, an information display method for a microwave oven according to an embodiment of the invention includes reading data including one of data requested by a user and data required to be notified to a user from a data storage device, displaying the read data on a screen, setting scroll directions for the displayed data, and scrolling the displayed data in the set scroll directions.

According to another embodiment of the present invention, an information display method for a microwave oven includes reading data including one of data requested by a user and data required to be notified to a user from a data storage device, displaying the read data on a screen, setting scroll rates for the displayed data, and scrolling the displayed data at the set scroll rates.

According to still another embodiment of the present invention, an information display method for a microwave oven includes reading data including one of data requested by a user and data required to be notified to a user from a data storage device, displaying the read data on a screen, setting scroll directions and rates for the displayed data, and scrolling the displayed data in the set scroll directions and at the set scroll rates.

According to an aspect of the invention, the setting of the scroll directions and the scroll rates includes manipulating one or more selection keys of an input unit.

According to another aspect of the invention, the setting of the scroll directions and the scroll rates includes manipulating a single one of the selection keys, wherein each pair of scroll direction and rate are changed whenever the single selection key is manipulated.

According to yet another aspect of the invention, the setting of the scroll directions and the scroll rates includes manipulating selection keys, where ones of the selection keys correspond to setting different scroll directions and rates.

According to still yet another aspect of the invention, the read data is transmitted through a communication port that is capable of communicating with another device.

According to a further aspect of the invention, the read data is transmitted from a detachable memory pack.

According to a further embodiment of the present invention, a microwave oven includes a display unit including a screen to display data while scrolling the data on the screen, a storage unit to store the data to be displayed on the display unit, an input unit to set scroll directions of the data to be displayed, and a control unit to control the display of the data while scrolling the data in the set scroll directions.

According to a still further embodiment of the present invention, a microwave oven includes a display unit including a screen to display data while scrolling the data on the screen, a storage unit to store the data to be displayed on the display unit, an input unit to set scroll rates of the data to be displayed, and a control unit to control the display of the data while the data is scrolled at the set scroll rates.

According to a yet further embodiment of the present invention, a microwave oven includes a display unit including a screen to display data while scrolling the data on the screen, a storage unit to store the data to be displayed on the display unit, an input unit to set scroll directions and rates of the data to be displayed, and a control unit to control the display of the data while the data is scrolled in the set scroll directions and at the set scroll rates.

According to an additional aspect of the invention, the input unit includes a single selection key that sets the scroll directions and rates, where the control unit changes the scroll direction and rate when a user manipulates the single selection key.

According to a yet additional aspect of the invention, the input unit includes selection keys to set the scroll directions and the scroll rates, where the control unit sets the scroll direction and the scroll rate in accordance with a manipulation of a corresponding one of the selection keys.

### BRIEF DESCRIPTION OF THE DRAWINGS

The above and other objects, features and other advantages of the present invention will be more clearly understood and more readily appreciated from the following detailed description taken in conjunction with the accompanying drawings, in which:

FIG. 1 is a block diagram of a conventional microwave oven;

FIG. 2 is a block diagram of a microwave oven in accordance with an embodiment of the present invention;

FIG. 3 is a view showing the screen of an input unit in accordance with another embodiment of the present invention;

FIG. 4 is a view showing the digit cells of the input unit according to a further embodiment of the present invention;

FIGS. 5a to 5e are views showing an operation of displaying data in accordance with an additional embodiment of the present invention;

FIGS. 6a and 6b are flowcharts showing an information displaying method for the microwave oven in accordance with yet another embodiment of the present invention;

FIGS. 7a and 7b are flowcharts showing another information displaying method for the microwave oven in accordance with still another embodiment of the present invention; and

FIG. 8 is a block diagram showing a microwave oven using the information displaying method according to an embodiment of the present invention.

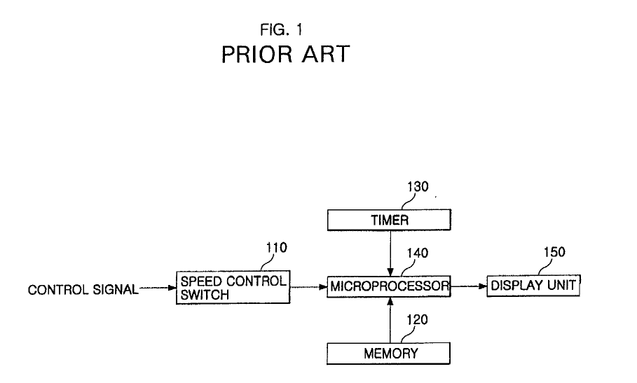

### DESCRIPTION OF THE PREFERRED EMBODIMENTS

Reference now is be made in detail to the present embodiments of the present invention, examples of which are illustrated in the drawings, in which the same reference numerals are used throughout the different drawings to designate the same or similar components. The embodiments are described below in order to explain the present invention by referring to the figures.

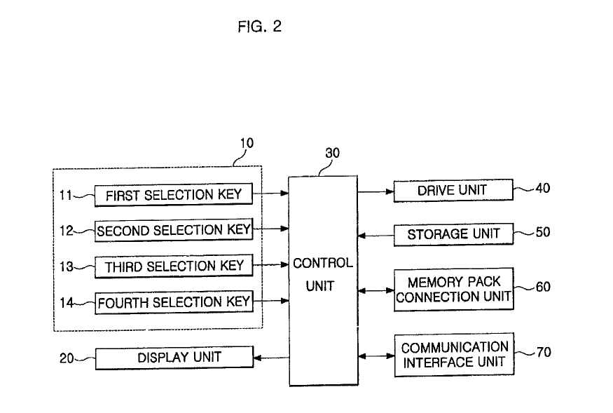

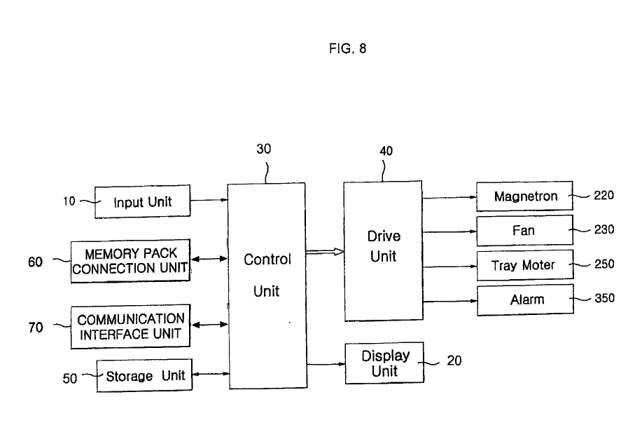

FIGS. 2, 3, and 8 are block diagrams of a microwave oven in accordance with an embodiment of the present invention. Referring to FIG. 2, the microwave oven includes a display unit 20 to display data. The data includes data requested by a user or which is required to be notified to a user on a screen 20a, but can be any type of data displayed by a microwave oven. An input unit 10 sets scroll directions and rates for data to be displayed on the screen 20a of the display unit 20. A control unit 30 controls the of scrolling of the data displayed on the screen 20a of the display unit 20 in the set scroll directions and rates. A drive unit 40 operates loads, such as a magnetron 220, a fan 230, a tray motor 250, and an alarm 350 and the like, according to the control of the control unit 30 so as to cook food.

In addition, the microwave oven of the present invention further includes a storage unit 50 to store the data to be displayed on the display unit 20, a memory pack connection unit 60 to connect with a portable storage device or storable memory pack (not shown), to read the data from the memory pack and to transmit the read data to the storage unit 50, a microprocessor (not shown) to access the Internet and to download the data from the Internet, and a communication interface unit 70 to transmit the downloaded data to the storage unit 50 according to a certain communication protocol (for example, RS-232C).

The input unit 10 includes a plurality of keys (a power key, number keys, etc. as typically found mounted on an existing microwave oven) to set the cooking conditions. Some of the keys are used to set a scroll direction and a scroll rate for the data to be displayed. In an embodiment of the invention, these keys include a first selection key 11 (a “1” number key) to scroll data backward character-by-character, a second selection key 12 (an “8” number key) to scroll data forward frame-by-frame, a third selection key 13 (a “2” number key) to scroll data backward frame-by-frame, and a fourth selection key 14 (a “9” number key) to scroll data forward character-by-character. When there is no need to input corresponding numbers (numbers of 1,2,8 and 9), such as in an operation mode in which data are displayed on the screen of the display unit 20, the first to fourth selection keys (11, 12,13 and 14) are used as selection keys to set the scroll direction and the scroll rate.

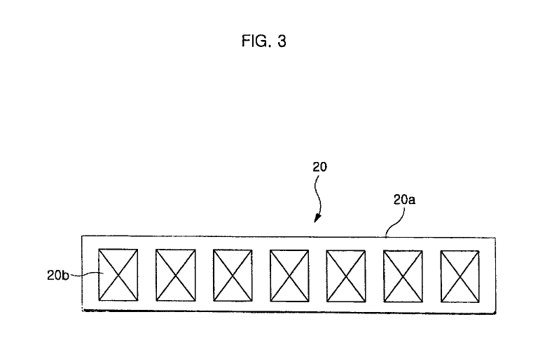

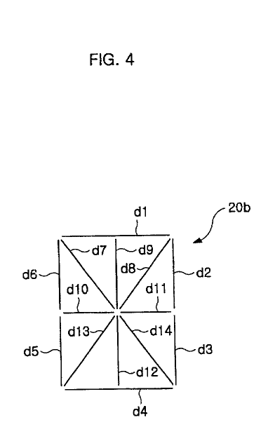

Referring to FIGS. 3 and 4, the display unit 20 displays data on the screen 20a and includes seven digit cells 20b. Each of the digit cells 20b displays a single datum by driving a plurality of digits d1 to d14 according to a display control signal from the control unit 30. When the power is turned on, the control unit 30 outputs a display control signal to the display unit 20 so as to scroll data on the display unit 20 in an initially set scroll direction and at an initially set scroll rate. When the scroll direction and rate of the data are set by manipulating the first to fourth selection keys of the input unit 10 as the data is being displayed in the initially set scroll direction and at the initially set scroll rate, the control unit 30 outputs to the display unit 20 a display control signal to scroll data in the set scroll direction and at the set scroll rate.

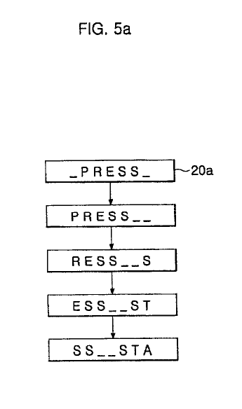

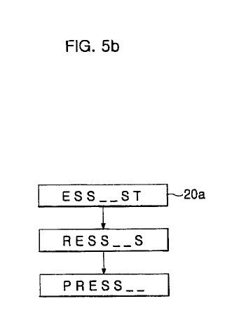

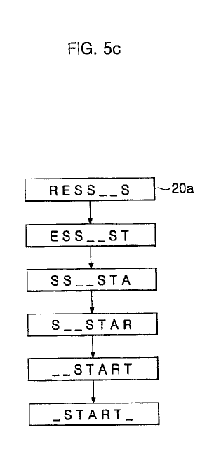

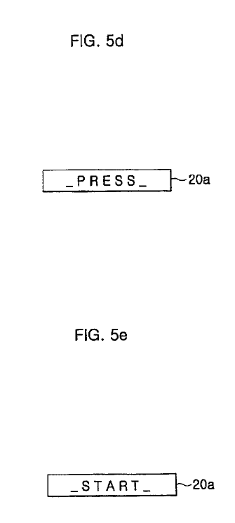

For example, as shown in FIGS. 5a through 5e, when power is turned on and a user manipulates a selection key to display the data of “PRESS START”, the control unit 30 outputs to the display unit 20 a display control signal to scroll the data according to initial conditions (scrolling data forward character-by-character) after reading data to be displayed from the storage unit 50. In this case, data, as shown in FIG. 5a, are displayed on the screen 20a in the order of “_PRESS_”, “PRESS_{——}”, “RESS_{——}S”, “ESS_{——}ST” and “SS_{——}STA” in sequence. Thereafter, as shown in FIG. 5b, when the user manipulates the first selection key 11 of the input unit 10 three times, the data, is displayed in the order of “ESS_{——}ST”, “RESS_{——}S” and “PRESS_{——}”in sequence. When the user manipulates the fourth selection key 14 of the input unit 10 six times, data, as shown in FIG. 5c, the data is displayed on the screen 20a in the order of “RESS_{——S”, “ESS}_{——}ST”, “SS_{——}STA”, “S_{——}STAR”, “_{——}START” and “_START_” in sequence. When the user manipulates the second selection key 12 of the input unit 10 one time, one frame of data (corresponding to seven digit cells) is scrolled forward and data displayed on the screen 20a which is shown in FIG. 5d as “_PRESS_”. When the user manipulates the third selection key 13 of the input unit 10 one time, one frame of data (corresponding to seven digit cells) is scrolled backward and the data displayed on the screen 20a is “_START_”.

The user can conveniently therefore confirm data because the user can scroll the data on a screen in a desired direction and at a desired rate using first to fourth selection keys of an input unit 10.

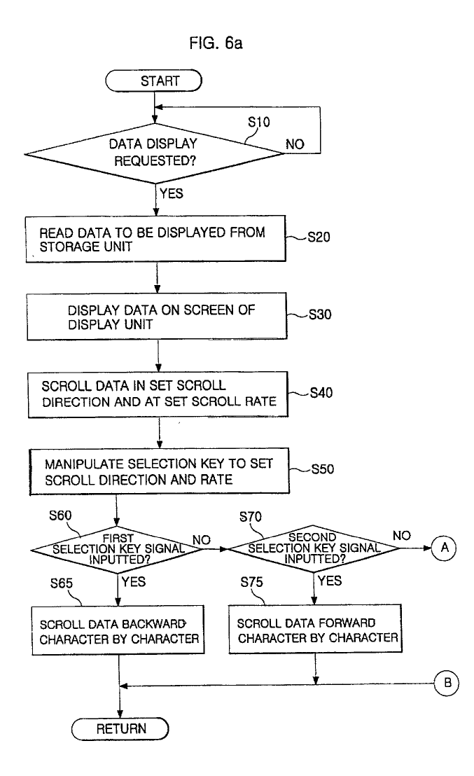

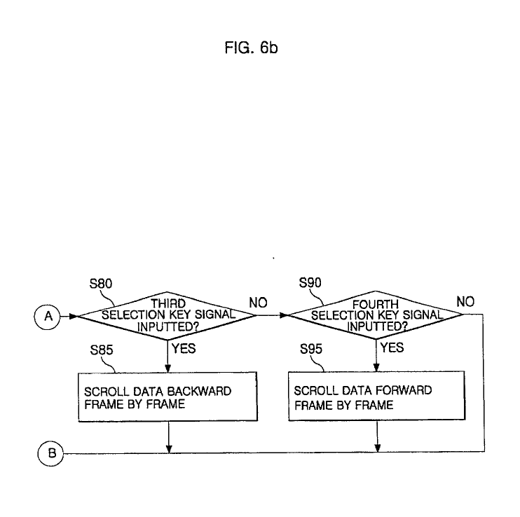

FIGS. 6a and 6b are flowcharts showing an information displaying method for the microwave oven in accordance with an embodiment of the present invention. Referring to FIGS. 6a and 6b, after the power is turned on and a user puts food to be cooked into the cooking chamber of the microwave oven, the control unit 30 determines whether there is need for displaying data to the user while desired cooking conditions are being set or whether data is to be notified to the user while a cooking operation is performed according to set cooking conditions (S10). If the need does not exist, this procedure returns to its initial step.

If the need exists, the control unit 30 reads the data to be displayed on the screen 20a from the storage unit 50 (S20). As shown, the data to be displayed on the screen can be previously stored in the data storage unit 50. However, the data can also be transmitted through the memory pack connection unit 60 from a memory pack in which additional data are stored. In a similar manner, the data to be displayed on the screen can be additionally transmitted through the communication interface unit 70 connected to a computer capable of downloading the data from the Internet or through a wireless network. That is, the data to be displayed on the screen can be properly added and changed when necessary at the step S20.

Thereafter, the control unit 30 outputs to the display unit 20 a display control signal to display the data read from the storage unit 50 based upon initial conditions (in a preset scroll direction and at a preset scroll rate). Subsequently, as shown in FIG. 5a, the data is displayed on the screen 20a of the display unit 20 while being scrolled forward character-by-character (S30 and S40).

Thereafter, when a user desires to review data having been displayed or to preview data to be displayed, the user manipulates a desired selection key among the first to fourth selection keys 11 to 14 of the input unit 10 so as to set the scroll direction and rate of the data (S50).

Thereafter, the control unit 30 determines whether the first selection key 11 is inputted (S60). If the first selection key signal is inputted, the control unit 30 controls the display unit 20 to display the data on the screen 20a while scrolling the data backward character-by-character (S65). Thereafter, this procedure returns to its initial step.

If the first selection key signal is not inputted, the control unit 30 determines whether the second selection key signal is inputted (S70). If the second selection key signal is inputted, the control unit 30 controls the display unit 20 to display data on the screen 20a while scrolling the data forward character-by-character (S75). Thereafter, this procedure returns to its initial step.

If the second selection key signal is not inputted, the control unit 30 determines whether the third selection key signal is inputted (S80). If the third selection key signal is inputted, the control unit 30 controls the display unit 20 to display the data on the screen 20a while scrolling the data backward frame-by-frame (S85). Thereafter, this procedure returns to its initial step.

If the third selection key signal is not inputted, the control unit 30 determines whether the fourth selection key 14 is inputted (S90). If the fourth selection key signal is inputted, the control unit 30 controls the display unit 20 to display data on the screen 20a while scrolling the data forward frame-by-frame (S95). Thereafter, this procedure returns to its initial step.

Although in the above-described embodiment, there is applied a manner of setting the scroll direction and rate of data by manipulating a plurality of selection keys 11 to 14, it is understood that the scroll direction and rate can be set by manipulating a single selection key and the data can be scrolled in the set scroll direction and at the set scroll rate. That is, whenever a user manipulates the single selection key, the scroll direction and rate of the data are set in a predetermined order.

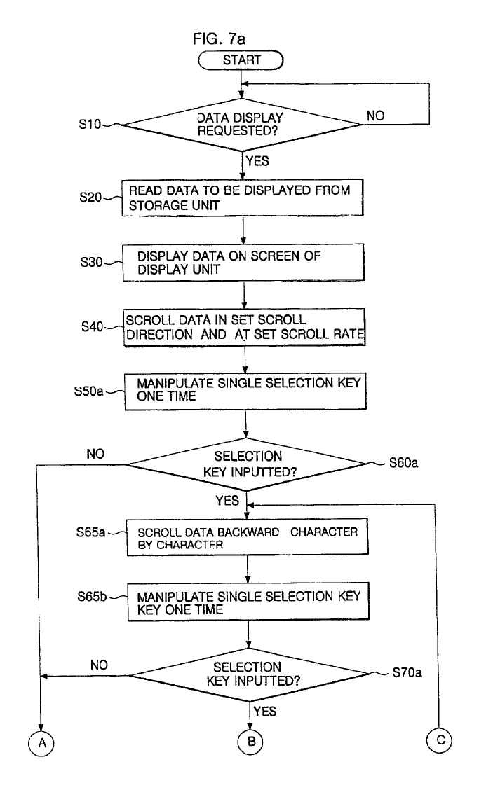

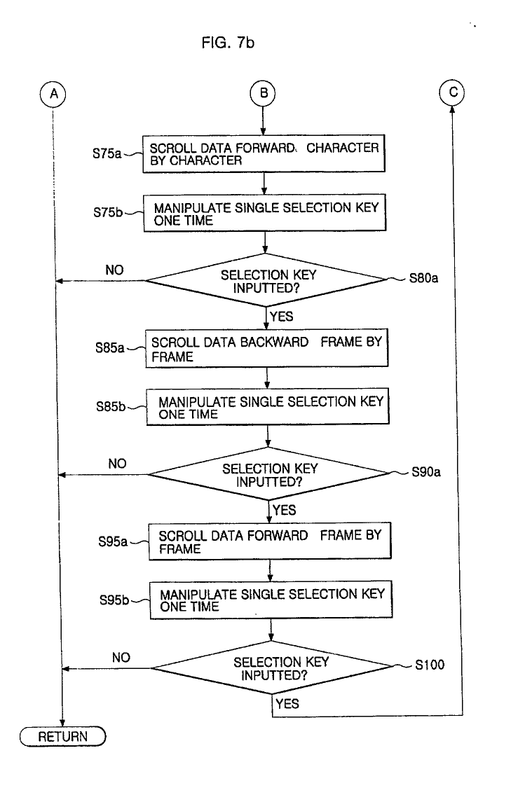

FIGS. 7a and 7b are flowcharts showing another information displaying method for the microwave oven according to another embodiment of the present invention. This method shown in FIGS. 7a and 7b is similar to the previously described method shown in FIGS. 6a and 6b except that a single selection key is used. Accordingly, an explanation of similar parts is omitted to avoid redundancy, but the explanation of different parts is described in detail.

After the operations S10 to S40 are performed, there is manipulated a single selection key (a predetermined single key) to set the scroll direction and rate of data one time (S50a).

Thereafter, the control unit 30 determines whether the selection key is inputted by a user (S60a). If the selection key signal is not inputted, this procedure returns to its initial step. If the selection key signal is inputted, the control unit 30 controls the display unit 20 to display data on the screen 20a while scrolling the data in a first scroll direction and at a first scroll rate (backward character-by-character) (S65a). Thereafter, the user manipulates the selection key once in order to change the set scroll direction and scroll rate (S65b).

Subsequently, the control unit 30 determines whether the selection key is inputted by the user (S70a). If the selection key signal is not inputted, this procedure returns to its initial step. On the other hand, if the selection key signal is inputted, the control unit 30 controls the display unit 20 to display the data on the screen 20a while scrolling the data in a second scroll direction and at the first scroll rate (forward character-by-character) (S75a). Thereafter, the user manipulates the selection key once in order to change the set scroll direction and rate (S75b).

Subsequently, the control unit 30 determines whether the selection key signal is inputted by a user (S80a). If the selection key signal is not inputted, this procedure returns to its initial step. On the other hand, if the selection key signal is inputted, the control unit 30 controls the display unit 20 to display the data on the screen 20a while scrolling the data in the first scroll direction and at the second scroll rate (backward frame-by-frame) (S85a). Thereafter, a user manipulates the selection key once in order to change the set scroll direction and rate (S85b).

Thereafter, the control unit 30 determines whether the selection key signal is inputted by the user (S90a). If the selection key signal is inputted, this procedure returns to its initial step. On the other hand, if the selection key signal is not inputted, the control unit 30 controls the display unit 20 to display the data on the screen 20a while scrolling the data in the second scroll direction and at the second scroll rate (forward frame-by-frame) (S95a). Thereafter, the user manipulates the selection key once in order to change the set scroll direction and rate (S95b).

Thereafter, the control unit 30 determines whether the selection key signal is inputted by the user (S100). If the selection key signal is not inputted, this procedure returns to its initial step. On the other hand, if the selection key signal is inputted, this procedure returns to the operation S65a, and so the control unit 30 controls the display unit 20 to display data on the screen 20a while scrolling the data in the first scroll direction and at the first scroll rate (backward character-by-character). Thereafter, whenever the user manipulates the selection key, the control unit 30 controls the display unit 20 to display data while scrolling the data in a set scroll direction and at a set scroll rate.

It is understood that the method shown in FIGS. 6a through 7b can be implemented using computer software encoded on a computer readable medium and readable by the control unit 30, which would be a computer according to an embodiment of the present invention.

As described above, the present invention provides a microwave oven and information displaying method for the same, in which the user can conveniently search for data because the user can scroll the data on a screen in a desired direction and at a desired rate using one or more selection keys of an input unit. Therefore, the microwave oven and method of the present invention can rapidly and conveniently display data having been display or to be displayed, so the convenience of use and the reliability of the microwave oven can be improved. It is understood that other mechanisms and combinations of selection keys to manipulate the scrolling direction and speed while the data is being scrolled on a screen are possible according to the present invention. Further, it is understood the information display method according to the present invention can be used in other applications to control the scrolling of data, both in other appliances and in other technologies where information is displayed.

Although the preferred embodiments of the present invention have been disclosed for illustrative purposes, those skilled in the art will appreciate that various modifications, additions and substitutions are possible, without departing from the scope and spirit of the invention as recited in the accompanying claims and equivalents thereof.

What is claimed is:

1. An information display method for a microwave oven, comprising:
reading data including one of data requested by a user and data required to be notified to the user from a data storage device;
displaying the read data on a screen;
setting scroll directions for the displayed data while the data is displayed on the screen; and
scrolling the displayed data in the set scroll directions.

2. An information display method for a microwave oven, comprising:
reading data including one of data requested by a user and data required to be notified to the user from a data storage device;
displaying the read data on a screen;
setting scroll rates for the displayed data while the data is displayed on the screen; and
scrolling the displayed data at the set scroll rates.

3. An information display method for a microwave oven, comprising:
reading data including one of data requested by a user and data required to be notified to a user from a data storage device;
displaying the read data on a screen;
setting scroll directions and rates for the displayed data while the data is displayed on the screen; and
scrolling the displayed data displayed in the set scroll directions and at the set scroll rates.

4. The method as set fourth in claim 3, wherein said setting the scroll directions and the scroll rates comprises manipulating one or more selection keys of an input unit to set the scroll directions and the scroll rates.

5. The method as set fourth in claim 4, wherein
the scroll directions and the scroll rates are set by manipulating a single one of the selection keys, and
pairs of scroll directions and rates are changed whenever the single selection key is manipulated.

6. The method as set fourth in claim 4, wherein the scroll directions and the scroll rates are set by manipulating the selection keys, and
the selection keys are manipulated to set corresponding different scroll directions and rates.

7. The method as set fourth in claim 3, wherein the read data is transmitted through a communication port that communicates with the a device exterior to the microwave oven.

8. The method as set fourth in claim 3, wherein the read data is transmitted from a detachable memory pack.

9. A microwave oven, comprising:
a display unit including a screen to display data while scrolling the data on the screen;
a storage unit to store data to be displayed on said display unit;
an input unit to set scroll directions of the data while the data is being displayed;
a control unit to control the display of the data while scrolling the data in the set scroll directions; and
an element driven in accordance with said control unit to produce microwaves.

10. A microwave oven, comprising:
a display unit including a screen to display data while scrolling the data on the screen;
a storage unit to store data to be displayed on said display unit;
an input unit to set scroll rates of the data while the data is displayed;
a control unit to control the display of the data while scrolling the data at the set scroll rates; and
an element driven in accordance with said control unit to produce microwaves.

11. A microwave oven, comprising:
a display unit including a screen to display data while scrolling the data on the screen;
a storage unit to store data to be displayed on said display unit;
an input unit to set scroll directions and rates of the data while the data is being displayed;
a control unit to control the display of the data while scrolling the data in the set scroll directions and at the set scroll rates; and
an element driven in accordance with said control unit to produce microwaves.

12. The microwave oven as set fourth in claim 11, wherein:
said input unit comprises a single selection key to set the scroll directions and rates, and
said control unit changes the scroll direction and rate according to a manipulation of the single selection key.

13. The microwave oven as set fourth in claim 11, wherein said input unit comprises selection keys to set the scroll directions and scroll rates, and
said control unit sets the scroll direction and rate according to a manipulation of ones of the selection keys.

14. An information display method for a microwave oven, comprising:
scrolling data on a screen to display the data, where the data comprises data units;
setting one of a scroll direction and a scroll rate while one of the data units is displayed on the screen; and
alternately scrolling the displayed data on the screen according to the set one of the scroll direction and the scroll rate while the one data unit is displayed.

15. The method according to claim 14, wherein
said scrolling the data comprises displaying the data according to a sequence of the data units, and
said setting the one of the scroll direction and the scroll rate comprises setting the scroll direction in a direction opposite to the sequence of the data units displayed during said scrolling the data.

16. The method according to claim 14, wherein said setting the one of the scroll direction and the scroll rate comprises:
receiving a scroll command, and
setting the scroll rate to sequentially display another one of the data units for each received scroll command.

17. The method according to claim 14, wherein said setting the one of the scroll direction and the scroll rate comprises:
receiving a scroll command, and
setting the scroll rate to sequentially display a group of the data units for each received scroll command.

18. The method according to claim 17, wherein the group of the data units corresponds to a display capacity of the screen.

19. A computer readable medium encoded with processing instructions for implementing a an information display method performed by a computer, the method comprising:
scrolling data on a screen to display the data, where the data comprises data units;
setting one of a scroll direction and a scroll rate while one of the data units is displayed on the screen; and
alternately scrolling the displayed data on the screen according to the set one of the scroll direction and the scroll rate while the one data unit is displayed.

20. The computer readable medium according to claim 19, wherein
said scrolling the data comprises displaying the data according to a sequence of the data units, and
said setting the one of the scroll direction and the scroll rate comprises setting the scroll direction in a direction opposite to the sequence of the data units displayed during said scrolling the data.

21. The computer readable medium according to claim 19, wherein said setting the one of the scroll direction and the scroll rate comprises:
receiving a scroll command, and
setting the scroll rate to sequentially display another one of the data units for each received scroll command.

22. The computer readable medium according to claim 19, wherein said setting the one of the scroll direction and the scroll rate comprises:
receiving a scroll command, and
setting the scroll rate to sequentially display a group of the data units for each received scroll command.

23. The computer readable medium according to claim 22, wherein the group of the data units corresponds to a display capacity of the screen.

24. The computer readable medium as set fourth in claim 19, wherein said setting one of the scroll direction and the scroll rate comprises setting the one of the scroll direction and the scroll rate in accordance with a received signal corresponding to a manipulation of one or more selection keys of an input unit.

25. The computer readable medium as set fourth in claim 24, wherein
both the scroll direction and the scroll rate is set in accordance with a signal corresponding to a manipulated single one of the selection keys, and
changing pairs of scroll directions and scroll rates according to additional signals from the single selection key is received.

26. The computer readable as set fourth in claim 24, wherein
the one of the scroll direction and the scroll rate is set by receiving the signal corresponding to a manipulated one of the selection keys, and
the selection keys are manipulated to set corresponding different ones of the scroll directions and the scroll rates.

27. A display mechanism for use in a device, comprising:
a display unit including a screen to display data while scrolling the data on the screen;
a storage unit to store the data to be displayed on said display unit;
an input unit to set one of a scroll direction and a scroll rate of the data while the data is being displayed; and
a control unit to control the display of the data while scrolling the data in the set scroll direction and at the set scroll rate.

28. The display mechanism as set fourth in claim 27, wherein:
said input unit comprises a single selection key to set the scroll direction and the scroll rate, and
said control unit changes the scroll direction and the scroll rate according to a manipulation of the single selection key.

29. The display mechanism as set fourth in claim 27, wherein said input unit comprises selection keys to set the scroll directions and scroll rates, and
said control unit sets the scroll direction and scroll rate according to a manipulation of ones of the selection keys.
